(19) United States
(12) Patent Application Publication
(10) Pub. No.: US 2015/0023591 A1
(43) Pub. Date: Jan. 22, 2015

(54) OPTICAL ANALYSIS OF A POINT OF AIM OF A PROJECTILE DISCHARGE DEVICE

(71) Applicant: RAMAKRISHNA POTLURI, INTELLECTTECH CORP PVT LTD, Hyderabad (IN)

(72) Inventor: Ramakrishna Potluri, Hyderabad (IN)

(21) Appl. No.: 13/944,928

(22) Filed: Jul. 18, 2013

(30) Foreign Application Priority Data
Jul. 18, 2013 (IN) 1914/CHE/2013

(51) Int. Cl. G06T 7/40; F41G 3/26

(52) U.S. Cl. CPC G06T 7/408; F41G 3/2605; G06T 2207/10024
USPC 382/162

(57) ABSTRACT

A system and method for performing an optical analysis of a point of aim of a projectile discharge device includes capturing and storing a first image in a first temporary storage location, capturing and storing a second image in a second temporary storage location, comparing the second image with the first image by employing an image processing technique decoding a plurality of color codes of the first image by an image processor and storing in a first two dimensional array, decoding a plurality of color codes of the second image by an image processor and storing in a second two dimensional array, comparing a plurality of matrix of elements of the first two dimensional array and the second two dimensional array and storing in a third two dimensional array and generating a binary outcome of an authorized user in a unique color chosen by the authorized user.

### TECHNICAL FIELD OF THE INVENTION

The present invention generally relates to an image processing system and method. More particularly, the present invention is related to a system and method of performing anoptical analysis of a point of aim of a projectile discharge device.

### BACKGROUND OF THE INVENTION

Pursuant to the development of computer graphics technology in recent years, a virtual world can now be represented even more realistically. Simulation devices have become widely popular for both business and domestic use. Conventionally available firearms improve skill of a shooter, especially with regards to aimingthrough repeated practice in controlled conditions. A virtual shooting range with the benefit of computer-simulations and other technological advancements, may have the further advantage of being able to provide sophisticated feedback for training purposes. For example, in some shooting range simulators, it may be possible to discern, not just whether a shooter hit or missed a target or by how much, but also factors that affect the shooter's aiming accuracy. Examples of such data are grip pressure, weapon orientation, response to weapon kick-back, and aiming history.

Aiming is a process that lasts for more than an instant of time and typically includes many slight adjustments by the shooter before the trigger is pressed. Additionally, there is typically a discrepancy between an aimed-at location and actual hit position. Therefore, it may be desired to track the aimed-at position during the aiming process, e.g., continually or shortly before firing. This tracking may be used to monitor the aiming history of a shooter.

Existing shooting simulator systems may include a target screen, a simulated weapon, and a processing center. In some existing systems, the target screen may include an array of photo-sensors, the aiming device may include a light beam emitter, and the processing center may include algorithms or circuits for determining where an aiming device is aimed or whether a particular target is hit, based on the photo sensors in the target screen detecting the light beam from the aiming device. Such a system may not be able to distinguish between multiple aiming devices aiming at the same position on the target screen.

In other existing systems, a particular target on the target screen may be marked by some property such as a distinctly colored pixel, the aiming device may include a detector for that property with a narrow field of view that is able to detect a target on the screen with a desired resolution and the processing center may include algorithms or circuits for determining whether the particular target is hit, based on the detector in the aiming device detecting the target property within the narrow field of view. Such a system may not be able to detect where an aiming device is aimed on the target screen unless it is perfectly aimed at the particular target, and thus may not be able to monitor misses or aiming in general and will give a hit or miss indication only.

In light of the aforementioned systems and methods, there clearly exists a need for an image processing system and optical analysis method for performing an optical analysis of a point of aim of a projectile discharge device for providing an enhanced real time experience to an authorized user.

### BRIEF SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In accordance with teachings of the present disclosure, an image processing system and optical analysis method for performing an optical analysis of a point of aim of a projectile discharge device for providing an enhanced real time experience to an authorized user.

A principal objective of the present invention is to provide a feedback to an authorized user describing shooting accuracy by performing optical analysis of the point of aim of the at least one projectile discharge device.

An objective of the present invention is to provide a feature rich computerized, professionally designed optical analysis of the point of aim of the at least one projectile discharge device.

Another objective of the present invention is to provide the safe and hazard-free projectile discharge device being both indoor and outdoor operable and completely portable, mimicking the actual real-time shooting experience.

Still another objective of the present invention is to provide an image processing system and optical analysis method for providing relative performance analysis reports to the authorized user.

Yet another objective of the present invention to facilitate single or multi user interface.

Another objective of the present invention is to provide an image processing system and optical analysis method capable of operating indoors and outdoors.

Exemplary embodiments of the present invention are directed towards a system and method of performing an optical analysis of a point of aim of a projectile discharge device According to a first aspect of the present invention, the method of performing anoptical analysis of a point of aim of aprojectile discharge device includes a step of capturing and storing at least one first image in a first temporary storage location.

According to the first aspect of the present invention, the method of performing an optical analysis of a point of aim of a projectile discharge device includes a step of capturing and storing at least one second image in a second temporary storage location.

According to the first aspect of the present invention, the method of performing an optical analysis of a point of aim of a projectile discharge device includes a step of comparing the at least one second image with the at least one first image by employing an image processing technique.

According to the first aspect of the present invention, the method of performing an optical analysis of a point of aim of a projectile discharge device includes a step of decoding a plurality of color codes of the at least one first image by an image processor and storing in a first two dimensional array.

According to the first aspect of the present invention, the method of performing an optical analysis of a point of aim of a projectile discharge device includes a step of decoding a plurality of color codes of the at least one second image by an image processor and storing in a second two dimensional array.

According to the first aspect of the present invention, the method of performing an optical analysis of a point of aim of a projectile discharge device includes a step of comparing a plurality of matrix of elements of the first two dimensional array and the second two dimensional array and storing in a third two dimensional array. The step of comparing the plurality of matrix of elements of the first two dimensional array and the second two dimensional array by passing through a centriod comparison filter. The centriod comparison filter performs at least one of a step of detecting a spot on a corner of two colors, a step of finding overlap of two bullets, a step of identifying a difference of color between a shot color pellet and a sparge on the target image and a step of identifying malfunctioning of the image processor after shot by the color pellet.

According to the first aspect of the present invention, the method of performing an optical analysis of a point of aim of a projectile discharge device includes a step of generating a binary outcome of at least one authorized user in a unique color chosen by the at least one authorized user. The method includes the step of generating binary outcome in a predefined color comprising passing the first two dimensional array and the second two dimensional array through a centroid comparison filter thereby comparing the plurality of matrix of elements in an iterative manner. The method includes a step of tracking and recording the binary outcome of the at least one authorized user for measuring a shooting accuracy of the point of aim of the aim of the projectile discharge device.

According to the first aspect of the present invention, the method of performing an optical analysis of a point of aim of a projectile discharge device further includes the step of measuring the shooting accuracy of the point of aim of the projectile discharge device employed by the at least one authorized user includes a step of successively projecting a spot from the projectile discharge device onto at least one target screen, a step of detecting the projected spot, a step of extracting the identifying characteristics from the projected spot, a step of storing the extracted identifying characteristics of that spot, a step of calculating a time taken by the at least one authorized user to perform a task, a step of measuring a miss distance of the point of aim and a step of calculating an outcome of the at least one authorized user.

According to the first aspect of the present invention, the method of performing an optical analysis of a point of aim of a projectile discharge device includes a step of generating at least one performance report related to measure shooting accuracy of the point of aim of the projectile discharge device employed by at least one authorized user after completing a chosen level.

According to the first aspect of the present invention, the method of performing an optical analysis of a point of aim of a projectile discharge device further includes a step of facilitating the at least one authorized user with a simulated target distance control on the projected image by measuring a pattern projection area to the authorized user and the plurality of projected images.

According to a second aspect of a present invention, a system of performing an optical analysis of a point of aim of a projectile discharge device is disclosed. The system includes at least one projectile discharge device.

According to the second aspect of a present invention, the system of performing an optical analysis of a point of aim of aprojectile discharge device includes at least one authorized user for employing the at least oneprojectile discharge device. The at least one authorized user further allowed to incorporate a plurality of type of patterns depicting different difficulty levels to the database.

According to the second aspect of a present invention, the system of performing an optical analysis of a point of aim of aprojectile discharge device includes at least one controller for controlling the optical analysis system.

According to the second aspect of a present invention, the system of performing an optical analysis of a point of aim of a projectile discharge device includes at least one target screen configured to display relevant information. The at least one target screen displays at least one of a level depending upon difficulty, a projectile discharge device, a color, a timer comprising a fixed timer, a slab timer and an unlimited timer, a sound enable and disable option, a status and a security details for controlling an operation. the status displayed on the at least one target screen includes a plurality of bullets used for current selection, an outcome of the at least one authorized user based on current selection, a timer running based on timer selection, a pause option enabled by pressing a space bar for discontinuing, a play option enabled by pressing the space bar for continuing, an escape option for enabling a termination.

According to the second aspect of a present invention, the system of performing an optical analysis of a point of aim of a projectile discharge device includes at least image recording device for capturing a plurality of images of the point of aim displayed on the at least one target screen.

According to the second aspect of a present invention, the system of performing an optical analysis of a point of aim of a projectile discharge device includes an image generating device for generating a plurality of images captured by the image recording device.

According to the second aspect of a present invention, the system of performing an optical analysis of a point of aim of aprojectile discharge device includes at least one elective projector for capturing a plurality of projected images

According to the second aspect of a present invention, the system of performing an optical analysis of a point of aim of a projectile discharge device includes at least one optical analysis means for performing an optical analysis of the plurality of captured images. The shooting performance of the at least one authorized user measure by comparing with a data base. the data base comprises at least one of an information related to the at least one authorized user, an information related to level type, a time, a binary outcome of the at least one authorized user and a shooting accuracy of the at least one authorized user.

According to the second aspect of a present invention, the system of performing an optical analysis of a point of aim of a projectile discharge device further generates at least one of a binary outcome of at least one authorized user in a unique color chosen by the at least one authorized user, a shooting accuracy of the at least one authorized user, a shooting performance of the at least one authorized user and a graphical analysis of shot count and the time taken by the at least one authorized user.

According to the second aspect of a present invention, the system of performing an optical analysis of a point of aim of a projectile discharge device further includes a plurality of fixed targets comprising a pattern with zoom in and zoom-out type visuals of images and a plurality of moving targets comprising an animation with default position recognition mechanism

### BRIEF DESCRIPTION OF THE DRAWINGS

Other objects and advantages of the present invention will become apparent to those skilled in the art upon reading the following detailed description of the preferred embodiments, in conjunction with the accompanying drawings, wherein like reference numerals have been used to designate like elements, and wherein:

FIG. 1 is a diagram depicting an over view of a system and method of performing an optical analysis of a point of aim of a projectile discharge device.

FIG. 2 is a flow diagram depicting a flow of a method of performing an optical analysis of a point of aim of a projectile discharge device according to an exemplary aspect of a present invention.

FIG. 3 is a functional block diagram illustrating multiple parameters considered for measuring shooting performance according to the embodiment of a present invention.

FIG. 4 is flowchart for explaining an operation of calculating a shooting accuracy in accordance with an exemplary embodiment of a present invention.

FIG. 5 is a flow diagram depicting multiple solutions to image processing constraints according to an embodiment of a present invention.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

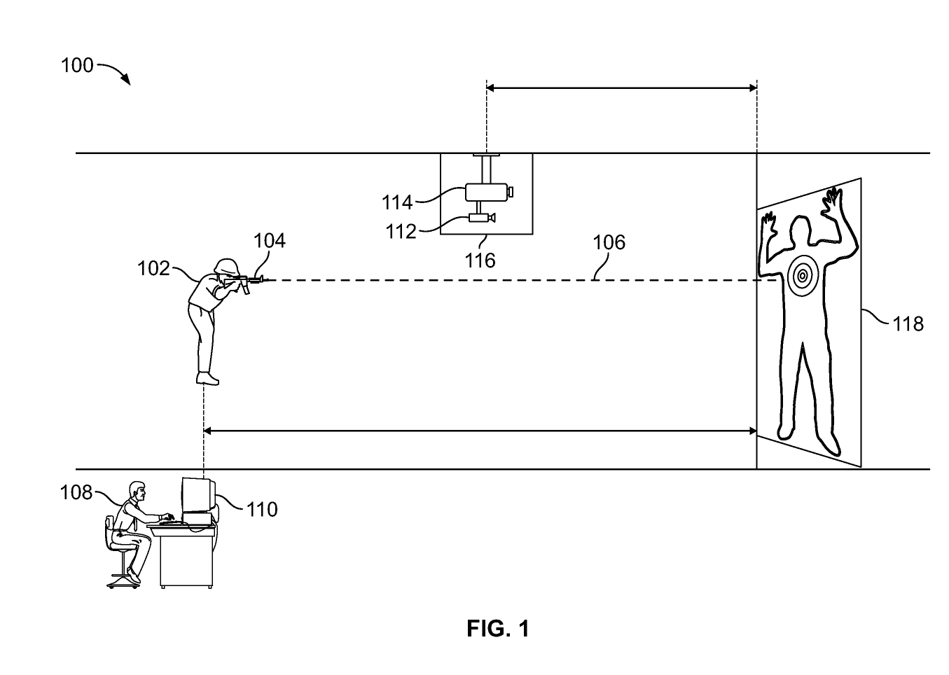

Referring to FIG. 1 is a diagram 100 depicting an over view of a system of performing an optical analysis of a point of aim of a projectile discharge device. According to an exemplary embodiment of the present invention, the optical analysis system includes an authorized user 102, a fire arm simulator 104 with pellets or bullets 106, a controller 108 for performing an operation of a computer 110, an image recording device 112, an elective projector 114, a physical protective shield 116 for protecting the image recording device 112 and the elective projector 114 and a target screen for display.

In accordance with a non limiting exemplary embodiment of the present invention, an authorization is provided to a user after entering the details in the optical analysis system. The details includes but not limited to a name, contact number, mobile .etc. The authorized user 102 selects a fire arm simulator 104 from group of variety of multiple projectile discharge device The multiple projectile discharge devices consists of either bullets or pellets 106. According to an exemplary aspect of the present invention, the controller 108 sitting near to the authorized user 102 controls and performs the operation by monitoring the authorized user 102. The controller 108 runs an application on the optical analysis system and ensures basic start setting of the optical analysis system. The authorized user 102 holds the chosen fire arm simulator 104 towards a target screen to shoot the target and the controller 108 confirms the authorized user 102 to start shooting.

According to a non limiting exemplary embodiment of the present invention, The optical analysis system scans shooting target area with the help of the image recording device 112. The image recording device 112 captures multiple images of the point of aim of the fire arm simulator while shooting a target displayed on the target screen 118. The target screen 118 displays a level type depending upon difficulty, a projectile discharge device type, a color to assign a particular authorized user, a timer including a fixed timer, a slab timer and an unlimited timer, a sound enable and disable option, a status, and a security details for controlling an operation. The elective projector 114 is required for capturing the projected images on the target screen 118. The mage recording device 112 and elective projector 114 are placed in a protective shield 116.

In accordance with an exemplary embodiment of the present invention, wherein the status displayed of the target screen 118 includes but not limited to a pellet or bullets used for current selection, an outcome of the authorized user based on current selection, a timer running based on timer selection, a pause option enabled by pressing a space bar for discontinuing, a play option enabled by pressing the space bar for continuing and an escape option for enabling a termination.

According to a non limiting exemplary embodiment of the present invention, the system further includes multiple fixed targets further including a pattern with zoom in and zoom-out type visuals of images and multiple moving targets further including an animation with default position recognition mechanism. The fixed targets and the moving targets are displayed on the target screen 118 and selected by the authorized user 112. The optical analysis system includes a data base including an information related to the authorized user, an information related to level type, a time, a binary outcome of the authorized user and a shooting accuracy of the authorized user.

In accordance with an exemplary embodiment of the present invention, the optical analysis system captures a first image and stores the first image in a first temporary storage location, captures a second image and stores the second image in a second temporary storage location. The second image stored in the second temporary storage location is compared with the first image stored in the first temporary storage location by using an image processing technique. Multiple color codes of the first image and the second image are decoded andstored in a first two dimensional array and a second two dimensional array respectively. The multiple matrix of elements of the first twodimensional array and the second two dimensional array are compared and stored in a third two dimensional array. The optical analysis further generates a binary outcome of the authorized user in a unique color.

According to a non limiting exemplary embodiment of the present invention, the comparison of the second image with the first image includes comparison of color data i.e R (Red), G (Green) and B (Blue) value of each element in the array will be compared and image processor will conclude the result in binary format. The first two dimensional array and the second two dimensional array are passed through a centroid comparison filter for comparing the matrix of elements in an iterative manner. The matrix of elements will be altered for five passes. First pass will contain 50% of the color which came as input to the centroid comparison filter. Next passes will be 40%, 30%, 20% and 10%. The centroid comparison filter gives output at any iteration which suits the array centroid detection with detected bullet or cola impression. Based on this information, the centroid comparison filter declares the outcome of the authorized user.

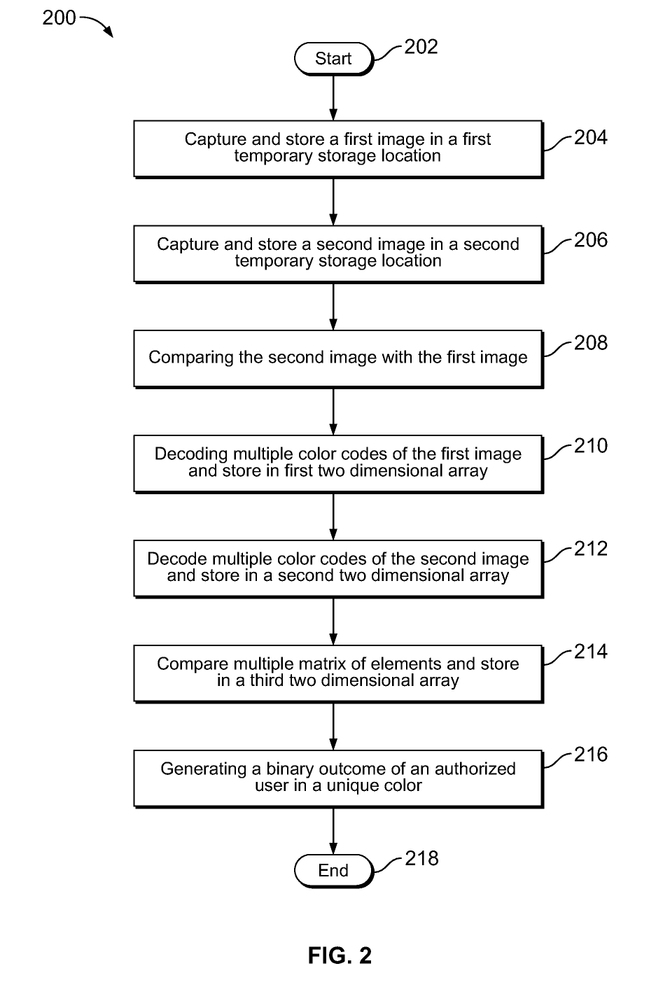

Referring to FIG. 2 is a flow diagram 200 depicting a flow of a method of performing an optical analysis of a point of aim of a projectile discharge device according to an exemplary aspect of the present invention. The flow diagram 200 start at step 202.

From step 202, the flow diagram 200 continues to step 204 depicting a step of capturing and storing a first image in a first temporary storage location. The image recording device captures the first image of the projectile discharge device pointing towards the target located on the target screen.

From step 204, the flow diagram 200 continues tostep 206 depicting a step of capturing and storing a second image in a second temporary storage location. The image recording device captures the second image of theprojectile discharge device pointing towards the target located on the target screen.

From step 206, the flow diagram 200 continues to step 208 depicting a step of comparing the second image with the first image by employing an image processing technique. From step 208, the flow diagram 200 continues to step 210 depicting a step of decoding multiple color changes of the first image by utilizing an image processor followed by an image processing technique. The multiple color changes of the first image are decoded by the image processing technique and stored in a first two dimensional array.

From step 210, the flow diagram 200 continues tostep 212 depicting a step of decoding multiple color changes of the second image by utilizing an image processor followed by an image processing technique. The multiple color changes of the second image are decoded by the image processing technique and stored in a second two dimensional array. From step 212, the flow diagram 200 continues to step 214 depicting a step of comparing multiple matrix of elements of the first two dimensional array and the second two dimensional array containing the multiple decoded color changes of the first image and second image are stored in a third two dimensional array.

From step 214, the flow diagram 200 continues to step 216 depicting a step of generating a binary outcome of the authorized user in a unique color chosen by the authorized user. The outcome is displayed on the target screen. The outcome includes but not limited to the score of the authorized user, shooting accuracy of the authorized user, shooting performance of the authorized user, graphical analysis further including shot count and time taken by the authorized user to perform the task.

Finally, the diagram 200 depicting a flow of a method of performing an optical analysis of a point of aim of a projectile discharge device ends at step 218.

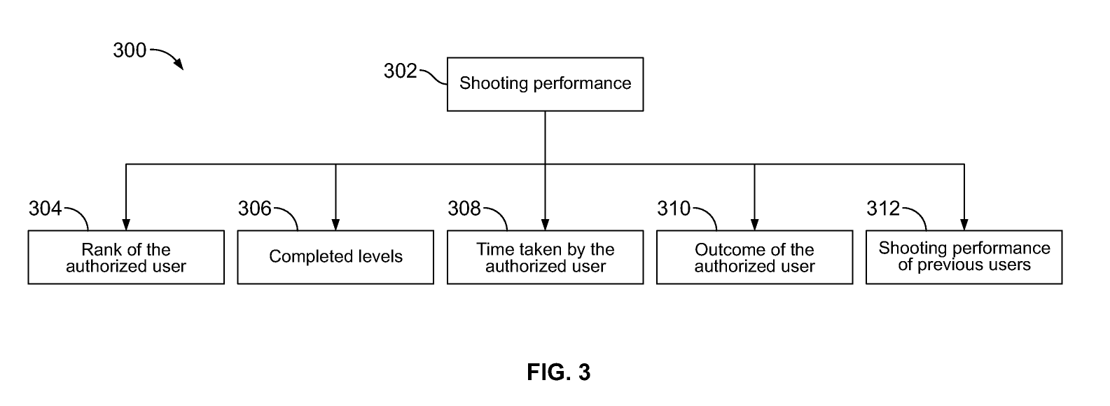

Referring to FIG. 3 is a functional block diagram illustrating multiple parameters considered for measuring shooting performance according to the embodiment of a present invention. The shooting performance 302 of the authorized user is measured by generate a rank of the current authorized user 304 with the database of the optical analysis system. The authorized user selects a level type, time frame and type of the projectile discharge device. The rank of the authorized is generated by considering all the authorized users completed the same level with same time selection. The database of the optical analysis system includes authorized user information and levels completed by the authorizer 306, time taken by the authorized user to complete a particular level 308, outcome of the authorized user after completing the level 310 and shooting performance of the previous authorized users.

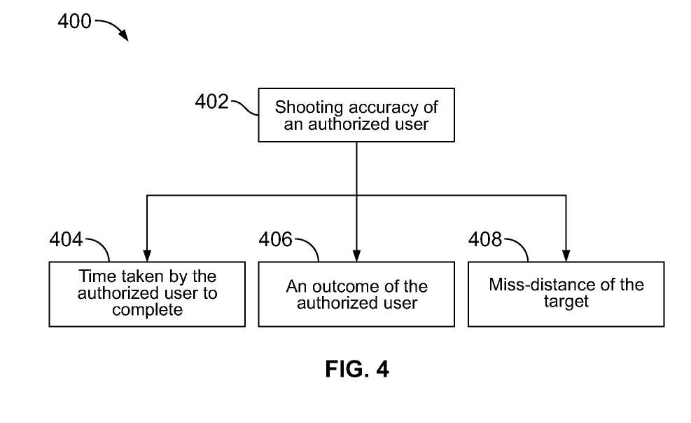

Referring to FIG. 4 is a flowchart 400 for explaining an operation of calculating a shooting accuracy in accordance with an exemplary embodiment of a present invention. The calculation of shooting accuracy of the authorized user 402 counted for a single authorized user mode only. The shooting accuracy is generated based on the time taken by the authorized user to finish the selected level 404, an outcome of the current authorized user 406 and miss-distance of target 408 which is displayed on the target screen. The target is displayed on the target screen in terms of different colors. The shooting accuracy of the authorized user is calculated based on the average of the above discussed factors in percentage (%).

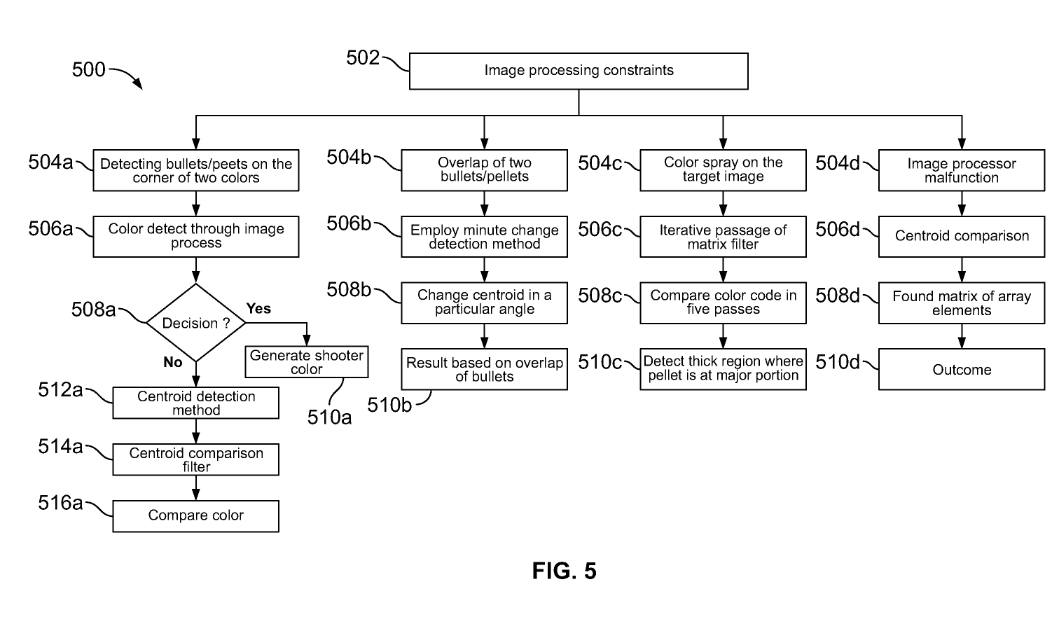

Referring to FIG. 5 is a flow diagram 500 depicting multiple solutions to image processing constraints according to an embodiment of a present invention. The flow diagram 500 starts a step 502 depicting image processing constraints.

From step 502, the flow diagram 500 continues to step 504a depicting a first image processing constraint disclosing a step of detecting bullets or pellets on the corner of two colors of a target displayed on the target screen. The process of detecting colors on the target is performed by image processing depicted at step 506a. From step 506a, the flow diagram 500 continues to step 508a disclosing a decision to confirm whether the color is detected or not. If the color is detected the flow diagram continues to step 510a depicting generating the authorized user color.

From step 508a, the flow diagram 500 continues to step 512a depicting a step of employing a centriod detection method. The centriod detection method utilizes a centriod comparison filterdepicted at a step 514a to detect the multiple colors on the target. Further detected the colors are compared at step 516a.

From step 502, the flow diagram 500 continues to step 504b depicting a second image processing constraint disclosing a step of finding overlap of two bullets or pellets. Two overlapped bullets or pellets are found by employing a minute change detection method at step 506b. In minute change detection method the time gap between the first bullet and the second bullet is calculated thereby detecting a minute change in the color comparison. A centriod filetr is utilized to the first image color detection results with second image colordetection which lead to a change with respect to the centroid in a particular angle at step 508b. Thus the optical analysis system provides the results based on the overlap of the bullets or pellets.

From step 502, the flow diagram 500 continues to step 504c depicting athird image processing constraint disclosing a step of detecting a color sparge on the target image when the authorized user shoots with a color pellet. The multiple color codes compared with an iterative passage of matrix at step 506c. After passing the imagesthrough the centriod filter, the centriod filter compares the multiple color codes of the images in five passes at step 508c. The comparison gives only thick region where the color pellet is located as a major portion at step 510c, ignoring a thin output.

From step 502, the flow diagram 500 continues to step 504d depicting a fourth image processing constraint disclosing a step of finding a malfunction of the image processor due to color drop on the target image when the authorized user shoots with color pellet. A centriod comparison is performed at step 506d to as the centriod comparison cannot give the output until the centriod comparison detects the matrix of array elements at step 508d. Finally the outcome is generated at step 10d.

While specific embodiments of the invention have been shown and described in detail to illustrate the inventive principles, it will be understood that the invention may be embodied otherwise without departing from such principles.

1. A method of performing an optical analysis of a point of aim of a projectile discharge device, comprising:
a step of capturing and storing at least one first image in a first temporary storage location;
a step of capturing and storing at least one second image in a second temporary storage location;
a step of comparing the at least one second image with the at least one first image by employing an image processing technique;
a step of decoding a plurality of color codes of the at least one first image by an image processor and storing in a first two dimensional array;
a step of decoding a plurality of color codes of the at least one second image by an image processor and storing in a second two dimensional array;
a step of comparing a plurality of matrix of elements of the first two dimensional array and the second two dimensional array and storing in a third two dimensional array; and
a step of generating a binary outcome of at least one authorized user in a unique color chosen by the at least one authorized user.

2. The method of claim 1, wherein the step of generating a binary outcome in a predefined color comprising passing the first two dimensional array and the second two dimensional array through a centroid comparison filter thereby comparing the plurality of matrix of elements in an iterative manner.

3. The method of claim 1 comprising a step of tracking and recording the binary outcome of the at least one authorized user for measuring a shooting accuracy of the point of aim of the aim of the projectile discharge device.

4. The method of claim 3 further comprising the step of measuring the shooting accuracy of the point of aim of the projectile discharge device employed by the at least one authorized user comprises:
a step of successively projecting a spot from the projectile discharge device onto at least one target screen;
a step of detecting the projected spot;
a step of extracting the identifying characteristics from the projected spot;
a step of storing the extracted identifying characteristics of that spot;
a step of calculating a time taken by the at least one authorized user to perform a task;
a step of measuring a misdistance of the point of aim; and
a step of calculating an outcome of the at least one authorized user.

5. The method of claim 1 comprising a step of generating at least one performance report related to measure shooting accuracy of the point of aim of the projectile discharge device employed by at least one authorized user after completing a chosen level.

6. The method of claim 1, wherein the step of comparing the plurality of matrix of elements of the first two dimensional array and the second two dimensional array by passing through a centriod comparison filter.

7. The method of claim 1, wherein the centriod comparison filter performs at least one of:
a step of detecting a spot on a corner of two colors;
a step of finding overlap of two bullets;
a step of identifying a difference of color between a shot color pellet and a sparge on the target image; and
a step of identifying malfunctioning of the image processor after shot by the color pellet.

8. The method of claim 1 further comprising a step of facilitating the at least one authorized user with a simulated target distance control on the projected image by measuring a pattern projection area to the authorized user and the plurality of projected images.

9. A system of performing an optical analysis of a point of aim of a projectile discharge device, comprising:
at least one projectile discharge device;
at least one authorized user for employing the at least one projectile discharge device;
at least one controller for controlling the optical analysis system;
at least one target screen configured to display relevant information;
at least image recording device for capturing a plurality of images of the point of aim displayed on the at least one target screen;
an image generating device for generating a plurality of images captured by the image recording device;
at least one elective projector for capturing a plurality of projected images; and
at least one optical analysis means for performing an optical analysis of the plurality of captured images.

10. The system of claim 9 further generates at least one of:
a binary outcome of at least one authorized user in a unique color chosen by the at least one authorized user;
a shooting accuracy of the at least one authorized user;
a shooting performance of the at least one authorized user; and
a graphical analysis of shot count and the time taken by the at least one authorized user.

11. The system of claim 10, wherein the shooting performance of the at least one authorized user measure by comparing with a data base.

12. The system of claim 11, wherein the data base comprises at least one of:
an information related to the at least one authorized user;
an information related to level type;
a time;
a binary outcome of the at least one authorized user; and
a shooting accuracy of the at least one authorized user.

13. The system of claim 9, wherein the at least one target screen displays at least one of:
a level depending upon difficulty;
a projectile discharge device;
a color;
a timer comprising a fixed timer; a slab timer; and an unlimited timer;
a sound enable and disable option;
a status; and
a security details for controlling an operation.

14. The system of claim 13, wherein the status displayed on the at least one target screen comprises:
a plurality of bullets used for current selection;
an outcome of the at least one authorized user based on current selection;
a timer running based on timer selection;
a pause option enabled by pressing a space bar for discontinuing;
a play option enabled by pressing the space bar for continuing;
an escape option for enabling a termination.

15. The system of claim 9, wherein the at least one authorized user further allowed to incorporate a plurality of type of patterns depicting different difficulty levels to the database.

16. The system of claim 9 further comprises:
a plurality of fixed targets comprising a pattern with zoom-in and zoom-out type visuals of images.
a plurality of moving targets comprising an animation with default position recognition mechanism.
